(19) United States
(12) Patent Application Publication
(10) Pub. No.: US 2017/0035638 A1
(43) Pub. Date: Feb. 9, 2017

(54) REHABILITATION MECHANISM FOR PATIENTS CONFINED TO BED AND BED COMPRISING THE REHABILITATION MECHANISM

(71) Applicant: REACTIVE ROBOTICS GMBH, Gilching (DE)

(72) Inventor: Alexander KOENIG, München (DE)

(73) Assignee: REACTIVE ROBOTICS GMBH, Gilching (DE)

(21) Appl. No.: 15/303,268

(22) PCT Filed: Apr. 13, 2015
(86) PCT No.: PCT/EP2015/057984

§ 371 Date: Oct. 11, 2016

(30) Foreign Application Priority Data
Apr. 13, 2014 (DE) 10 2014 105 250.1

(51) Int. Cl. A61H 1/02; A63B 21/005; A63B 21/068; G09B 5/06; A63B 22/00; A63B 22/06; A63B 24/00; A63B 21/00; A63B 21/16

(52) U.S. Cl. CPC A61H 1/024; A61H 1/0214; A61H 1/0229; A61H 1/0255; A61H 1/0262; A61H 1/0266; A63B 21/00181; A63B 21/0058; A63B 21/068; A63B 21/1672; A63B 21/4011; A63B 21/4015; A63B 21/4034; A63B 22/0056; A63B 22/0605; A63B 24/0087; G09B 5/06; A61H 2201/0142; A61H 2201/0157; A61H 2201/0161; A61H 2201/0192; A61H 2201/163; A61H 2201/1642; A61H 2201/5069; A61H 2201/5071; A61H 2203/0456; A61H 2230/605

(57) ABSTRACT

The invention relates to a rehabilitation mechanism (30) implemented for planned, automated rehabilitation of at least the joints, muscles, and tendons of the legs (92) of a bedridden patient (90) and comprising at least:
a foot module (40) for operatively connecting to the feet (94) of the bedridden patient (90),
a knee module (50) for operatively connecting to the knee joints (93) of the bedridden patient (90), and
a control module (60) for controlling planned rehabilitation motions of at least the joints, muscles, and tendons of the legs (92) of the bedridden patient (90) by means of the foot (40) and/or knee module (50).

The invention is further characterized in that at least the knee module (50) is implemented as a module for disposing between the patient (90) and the mattress (20) and supported directly or indirectly on a bed (11) or mattress frame (21).

The modular design of the rehabilitation mechanism (30) has the advantage that bedridden and particularly intensive-care patients (90) can receive planned, automated rehabilitation directly in the bed (10), wherein said bed can be implemented as a hospital bed, clinical bed, gurney, and/or intensive-care bed, without requiring high-risk transfer between beds and/or the ability to cooperatively contribute.

The present invention relates to a rehabilitation mechanism for bedridden patients and a bed comprising the rehabilitation mechanism, particularly a hospital bed, clinical bed, gurney, or intensive-care bed.

Persons suffering from an illness or as a result of an accident, for example, or who are “bound” to a bed as a patient for other reasons for longer than the normal nighttime rest period (referred to below as bedridden patients) often have restrictions on activity that lead to such persons being poorly able or even unable to participate in social life after leaving the bed, that is, unable or only partially able to work and requiring assistance in daily life.

Through rehabilitation, the patient can regain part of his activity. In the medical field, rehabilitation means the application and effects of measures intended for reducing to a minimum the physical, psychological, and social consequences of a handicap or limitation on activity (formerly: disability, now: activity) and interruption of participation (formerly, handicap; now, participation) in social life.

Medical rehabilitation has been proven to be particularly significant for the human locomotor system. If the bones, joints, muscles, and tendons, particularly of the human legs (comprising the buttocks, hip joint, thigh, knee joint, calf, and foot) are not moved regularly, they will stiffen—the related locomotion centers located in the human spinal tissue can atrophy.

Unlike persons who are physically able and have a stable circulatory situation allowing participation in treadmill training, for example, said training is typically denied to bedridden patients. The particular reasons can be orthopedic, intensive-care, and/or neurological limitations on activities encountered individually or cumulatively.

### Rehabilitation of Orthopedic Restrictions on Activity

Orthopedics is the field of activity of a specialist for orthopedics and trauma surgery and addresses the occurrence, prevention, detection, and treatment of congenital or acquired defects in the form or function of the musculoskeletal system, that is, the bones, joints, muscles, and tendons, and the rehabilitation of such patients.

Orthopedic treatments include surgical methods such as particularly prosthetic surgery (e.g., but not limited to, hip or knee joint replacement). After an accident or surgical intervention, bedridden patients are typically not able to apply full body weight to the bones, joints, muscles, and tendons of one or both legs due to orthopedic limitations on activity.

In order to nevertheless prevent stiffening of the legs, an in-bed exercise machine is know from WO 00/45897 A1, for example, allowing performing of cyclical leg motions in a reclined position when pushed up to the end of a hospital or clinical bed. The known in-bed exercise machine, however, particularly does not allow exercise in a vertical position. In order for the feet to be fully or partially loaded by the body's own weight, however, which can accelerate the healing process after a joint replacement or bone fracture, for example, it is necessary to be able to bring the bedridden patient completely or partially into a vertical position.

Said consideration is addressed, for example, by the standing table disclosed by WO 00/61059 A1. It is thereby problematic that said standing table or comparable known devices are typically located in a separate training room, but in any case require relocating the patient from the bed to the corresponding rehabilitation device. At least for intensive-care patients, but also for patients requiring intensive-care treatment, this is generally not possible, but in any case is associated with particular risks.

### Rehabilitation of Intensive-Care Limitations on Activity

Intensive care is a medical specialty addressing the diagnosis and therapy of life-threatening conditions and illnesses. Intensive-care services are typically provided in specially equipped units of a hospital or clinic, known as intensive-care units, led by specially trained specialists such as anesthesiologists, internists, surgeons, or neurologists.

The results of intensive-care services cover a wide range, depending on the underlying illness. In principal, there must be a certain positive prognosis of the illness condition. The goal of intensive-care services is namely to restore full health or at least to achieve a largely autonomous condition for the patient. So-called life-extending measures, therefore, are not pursued for their own sake.

Patients are admitted to intensive-care units whose condition is life-threatening or could become life-threatening, particularly due to a weak cardio-circulatory system, risk of cardiac arrest, infection risk, and the like. Said fact is addressed in standardized monitoring measures in intensive-care units.

Intensive-care units have extensive technical building structures and equipment. A focal point is the design of the intensive-care bed, which serves for safely supporting the most ill patients in intensive-care units. In addition to apparatus supporting the monitoring measures, an intensive-care bed is particularly characterized by a mattress suitably designed for preventing bedsores and for immediately manually resuscitating at least the heart and/or lungs of an intensive-care patient. The mattress must also be non-conductive for performing defibrillation and resistant to liquids, blood, and wipe-down disinfection using commercially available disinfecting agents.

In order to secure intensive-care patients against falling out of bed, the mattress is usually enclosed by barriers on the long and transverse sides that can be attached to the long and transverse sides of a bed or mattress frame and often support at least part of the monitoring apparatus.

Due to said typical design of intensive-care beds, the known rehabilitation devices described above cannot be easily brought adjacent to a modern intensive-care bed and/or require repositioning of the patient. The latter, however—as has already been mentioned—is typically not possible for intensive-care patients, who are normally weak or require intensive-care services for other reasons, but in any case is associated with special risks.

Meanwhile, patients in intensive-care units already have a five to ten times higher risk of infection in comparison with patients in normal units. Various infection-promoting factors add up for intensive-care patients, originating both from the patients themselves and from the treatment measures using in intensive care (many catheters, tubes, etc.) Therefore, in order to reduce the risk of infection, special hygienic measures are specified for intensive-care unit, and rehabilitation devices such as the known in-bed exercise machine or known standing table meet such specifications only with difficulty.

Rehabilitation strategies supported by rehabilitation devices therefore have typically been first used up to now after the patient has left the intensive-care unit.

### Rehabilitation of Neurological Limitations on Activity

Neurology is the study of diseases of the nervous system. The organ system that are addressed in neurology are the central nervous system, that is, the brain and spinal cord, surrounding structures and blood-supply vessels thereof, and the peripheral nervous system including structures thereof connecting to the muscles, and the musculature.

For neurological rehabilitation, recent studies have shown that rehabilitation should begin as early as possible. In order to maximum the success of rehabilitation, for example, rehabilitation measures should be started 24 hours after a stroke exhibiting unilateral or other paralysis, or a traumatic brain injury with or without quantitative loss of consciousness, presenting as a coma in the most severe form.

Because patients affected by paralysis and/or loss of consciousness are typically still in an intensive-care unit at this point in time, the neurological rehabilitation strategies to be begun at an early point are doubly difficult: in addition to the intensive environment describe above, which is problematic in itself, the entire leg motion must be performed cyclically solely by the rehabilitation device, at least for paralyzed and/or comatose patients, at least at first.

For these reasons, exercises for maintaining activity of patients in intensive-care facilities are mostly performed by special physical therapists who manually move the limbs of intensive-care patients—daily if possible, but at least several times a week. Said manual physical therapy is disadvantageous in that the therapists can fatigue quickly due to the physical exertion, leading to difficulty in planning, let alone evaluating, session progress. Furthermore, it is not guaranteed that the physical therapist will work at the same (maximum) effort and efficiency for every physical therapy session. The physical therapist also cannot perform an objective quantification of the activity of the patient, only subjective, making objective quantification of the success of the therapy over several therapy sessions difficult. Finally, a therapy session, particularly in the intensive-care environment, can require not only the presence of one or more physical therapists, but also the presence of a nurse who must monitor the vital parameters of the patient [90] during the session, for example in order to be able to react to cardiac circulatory problems. The additional presence of highly qualified clinical personnel causes such therapy sessions to be unaffordable.

On this basis, the object of the present invention is to provide an improved rehabilitation mechanism in comparison with the prior art, particularly for patients having become bedridden due to orthopedic, intensive-care, and/or neurological limitations on activity, allowing planned, automated rehabilitation of at least the joints, muscles, and tendons of the legs of bedridden patients without requiring bed-to-bed transfer of the patient. In addition to commercially available or self-built hospital or clinical beds, the rehabilitation mechanism should also be usable in commercially available or self-built gurneys or intensive-care beds, regardless of whether the bedridden patient can be brought into a partially or completely vertical position in the corresponding bed, wherein the rehabilitation mechanism can support a rhythmic loading and unloading of the soles of the feet of bedridden patients in any position of the bedridden patient between a horizontal and a vertical position.

Said object is achieved first by a rehabilitation mechanism having the features of the independent claim 1.

A rehabilitation mechanism according to the invention implemented for planned, automated rehabilitation of at least the joints, muscles, and tendons of the legs of a bedridden patient, comprises at least:
a foot module for operatively connecting to the feet (94) of the bedridden patient,
a knee module for operatively connecting to the knee joints of the bedridden patient, and
a control module for controlling planned rehabilitation motions of at least the joints, muscles, and tendons of the legs of the bedridden patient by means of the foot and/or knee module.

The invention is further characterized in that at least the knee module is implemented as a module for disposing between the patient and the mattress and supported directly or indirectly on a bed or mattress frame.

The modular design of the rehabilitation mechanism has the advantage that bedridden and particularly intensive-care patients can receive planned, automated rehabilitation directly in the bed, without requiring high-risk transfer between beds and/or the ability to cooperatively contribute.

The term “module” or “modular design” should be understood hereafter particularly such that components so designated form individual, self-contained assemblies, indeed operatively connected to further elements but reversibly separable for the purpose of storing and/or transporting. The modules, particularly the foot module and the knee module, are fully mechanical and electrically separable form a bed on which said modules are used and can thus be stored separably. Alternatively or additionally, said modules can be folded away, for example in a space beneath a mattress of a bed.

The modularity, removability, or separability of the foot and knee module from the bed, whether by separating or by storing the therapy module beneath the bed, is particularly advantageous because the bed can be used as a normal bed outside of the therapy periods. The term “normal use” is understood thereby to mean that no element of the rehabilitation mechanism prevents access to the patient from all sides in any form, prevents the transfer from or into the bed, or prevents or hinders any necessary emergency measures or care measures.

The rehabilitation mechanism can preferably be reversibly releasably fixed to a hospital bed, in particular a conventional hospital bed. Said mechanism is provided and set up for reversibly disposing on conventional hospital beds in order to thus provide therapy for a patient lying in the bed. The rehabilitation mechanism preferably comprises support and/or clamping means in order to achieve reversible fixability. The rehabilitation mechanism can preferably be removed from a hospital bed as a module, particularly from a conventional hospital bed, and/or can be stowed beneath the hospital bed. The use of the rehabilitation mechanism is thereby substantially simplified. Said module is a self-contained system usable selectively on existing hospital beds.

Disposing a knee module between the patient and mattress and supporting the same directly or indirectly on a bed or mattress frame particularly makes it possible to apply supporting force to the knee joints of bedridden patients, advantageously rhythmically loading and unloading the soles of the feet of said patients, in any position assumed by the patient between a horizontal and a vertical position.

For orthopedic patients, the rhythmic loading and unloading of the soles of the feet is important, for example to accustom an injured joint to walking again and/or to a load in a partially or fully vertical assumed position. For intensive-care patients, the rhythmic loading and unloading of the soles of the feet is significant in order to prevent stiffening of the legs and atrophy of the locomotion centers located in the spinal cord.

For neurological patients, the alternating motion generates additional sensory input in the soles of the feet, said input being transmitted to the central nervous system. Said “efferent sensory input” ensures that the brain regions involved in generating walking motions are also excited.

The planned automated rehabilitation of at least the joints, muscles, and tendons of the legs of bedridden and particularly intensive-care patients by means of a rehabilitation mechanism according to the invention has the objective of limiting to a minimum the limitations on activity and/or interruption in participation in social life. The underlying central therapeutic idea is to quantify and/or control to a desired level the activity of bedridden or particularly intensive-care patients as early as possible, that is, while still in bed. The determining of individual parameters of a planned automated rehabilitation in this respect in the course of the present invention is nevertheless the responsibility of physical therapists or at least comparably trained technicians in practice.

The rehabilitation is particularly preferably a walking motion, a stepping motion, and/or a motion simulating stair-climbing. A walking motion, stepping motion, or motion simulating stair-climbing is substantially more advantageous for rehabilitation than a bicycle-riding motion, for example. A pure foot module allowing a bicycle-riding motion is known from DE 41 13 135 A1, for example. It is much more important, however, for rehabilitation patients to acquire a walking motion, stepping motion, or motion simulating stair-climbing and to simulate the loads occurring during such a walking motion, stepping motion, or motion simulating stair-climbing, and to measure progress thereby. A bicycle-riding motion is suitable only under certain conditions, as here in particular no rolling of the foot occurs and a torque applied to the ankle joint of the foot tends to be low.

According to the invention, the foot module and the knee module together form an exoskeleton for the patient. The modules forming the exoskeleton act together by means of the control module and support the patient in performing the motion. The rehabilitation mechanism further preferably comprises a biofeedback module for providing a visual and/or audible feedback to the patient. Such a biofeedback module preferably comprises a display or the like disposed in the field of vision of the patient in order to give said feedback. Such a biofeedback module can fundamentally be implemented as disclosed in US 2010/0042022 A1. Said module is preferably implemented for indicating to the patient whether said patient is performing a motion properly and/or is making progress. The biofeedback module is further preferably implemented for indicating to the patient that said patient is not performing a motion correctly, should change exercises, should stop an exercise, and the like.

The object of the present invention is therefore also a bed comprising the rehabilitation mechanism according to the invention, wherein said bed can be implemented as a commercially available or self-built hospital bed, a clinical bed, a gurney, or particularly an intensive-care bed.

Advantageous embodiments and refinements, usable individually or in combination with each other, are the objects of the dependent claims.

Said details and additional details and further advantages of the invention are described below using preferred embodiment examples, to which, however, the present invention is not limited, and in conjunction with the attached drawing. They show schematically:

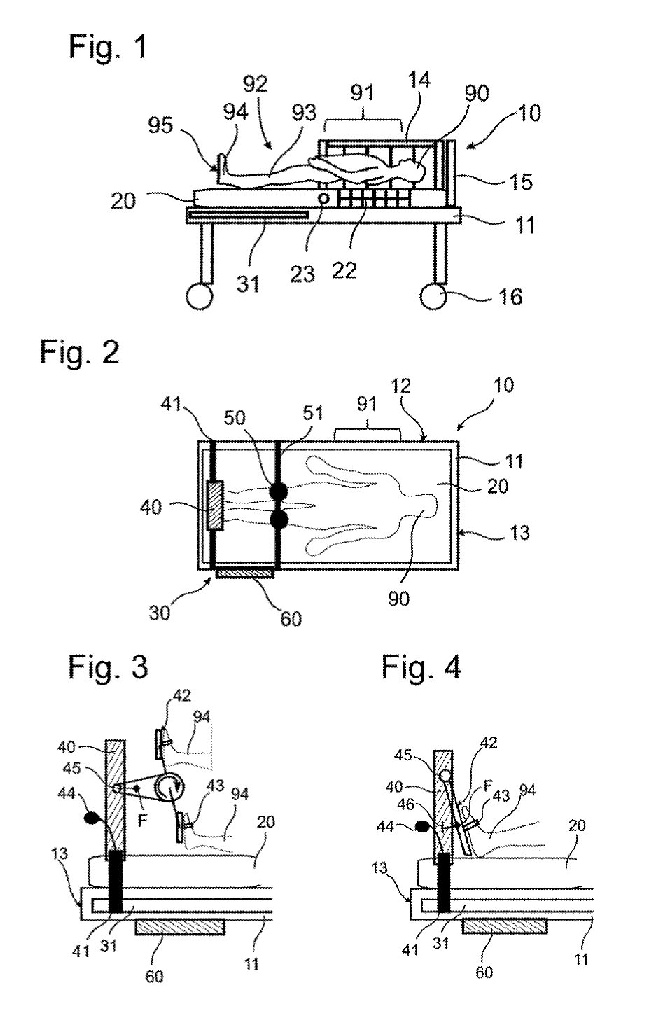

FIG. 1 A bedridden or intensive-care patient in a commercially available bed, particularly an in intensive-care bed, in a side view;

FIG. 2 A rehabilitation mechanism disposed on a bed according to FIG. 1 and comprising a foot module, a knee module, and control module in a plan view;

FIG. 3 A first embodiment example of a foot module having an electrical and/or mechanical design in a side view;

FIG. 4 A second embodiment example of a foot module having an electrical and/or mechanical design in a side view;

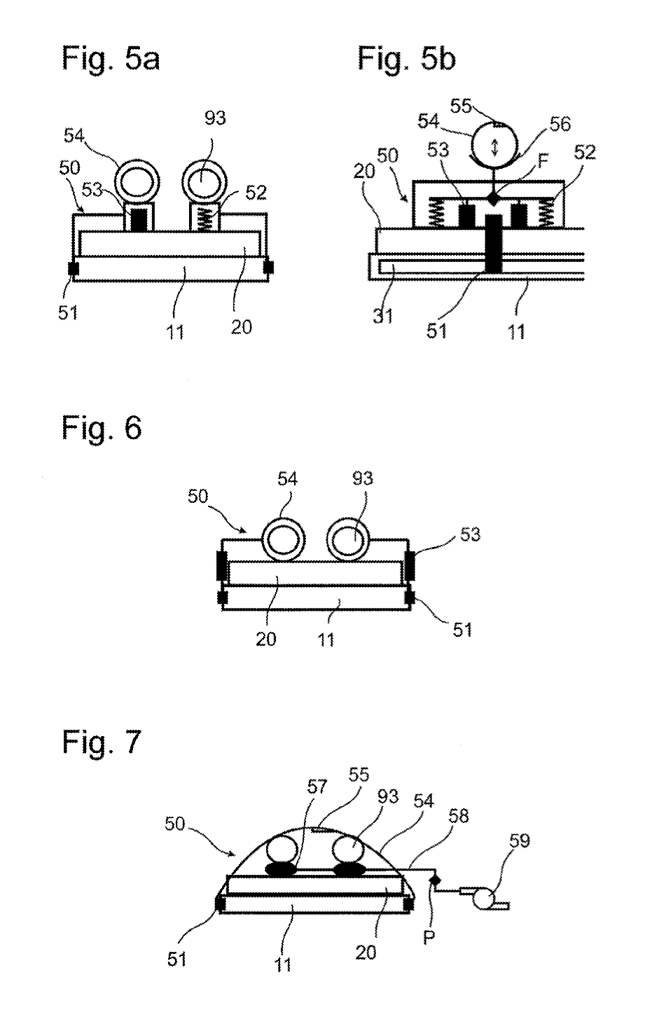

FIG. 5 A first embodiment example of a knee module having an electrical and/or mechanical design in a section view (FIG. 5a) and a side view (FIG. 5b);

FIG. 6 A second embodiment example of a knee module having an electrical and/or mechanical design in a section view;

FIG. 7 An embodiment example of a knee module having a fluid-dynamic design in a section view;

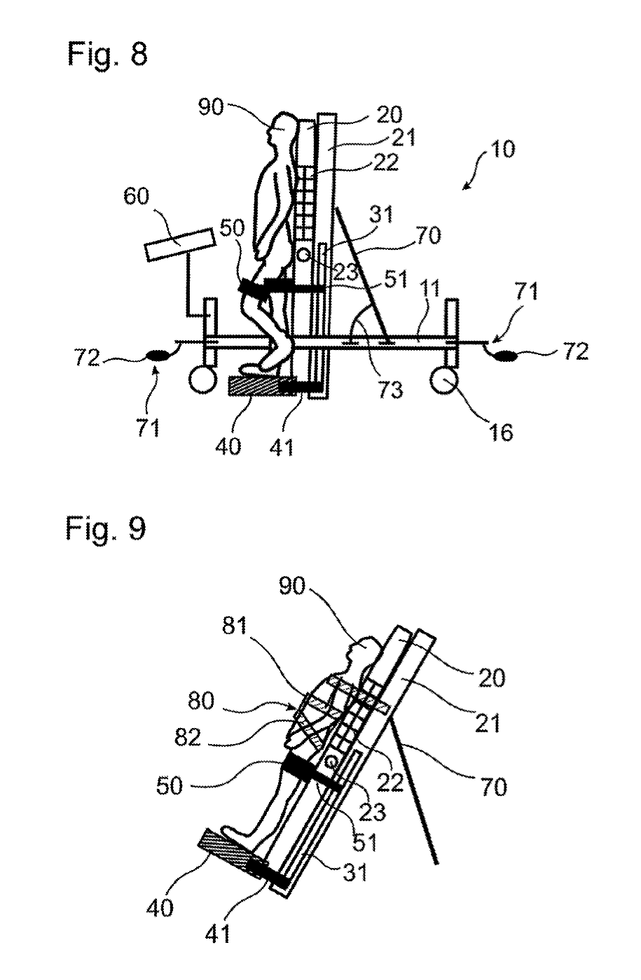

FIG. 8 An embodiment example of an adjusting mechanism for raising the mattress frame by e.g. 90° to a vertical position, in a side view;

FIG. 9 A first embodiment example of a stabilizing mechanism at a vertical level of e.g. 60°, in a side view.

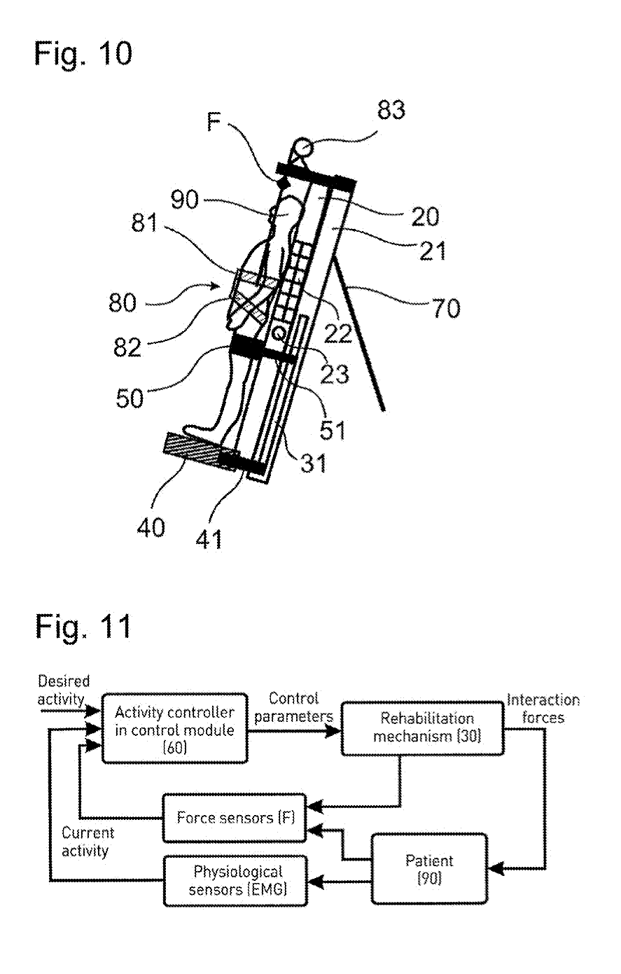

FIG. 10 A second embodiment example of a stabilizing mechanism at a vertical level of e.g. 75°, in a side view.

FIG. 11 A control schematic of the control module for controlling and executing planned rehabilitation motions;

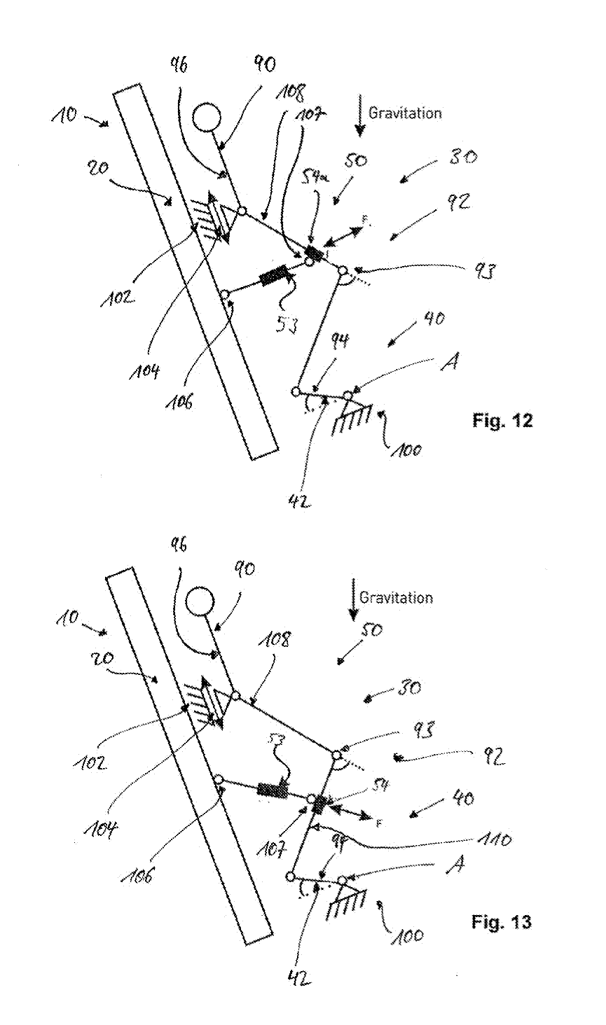

FIG. 12 A schematic view of a bed having a rehabilitation mechanism according to a first embodiment example;

FIG. 13 A schematic view of a bed having a rehabilitation mechanism according to a second embodiment example;

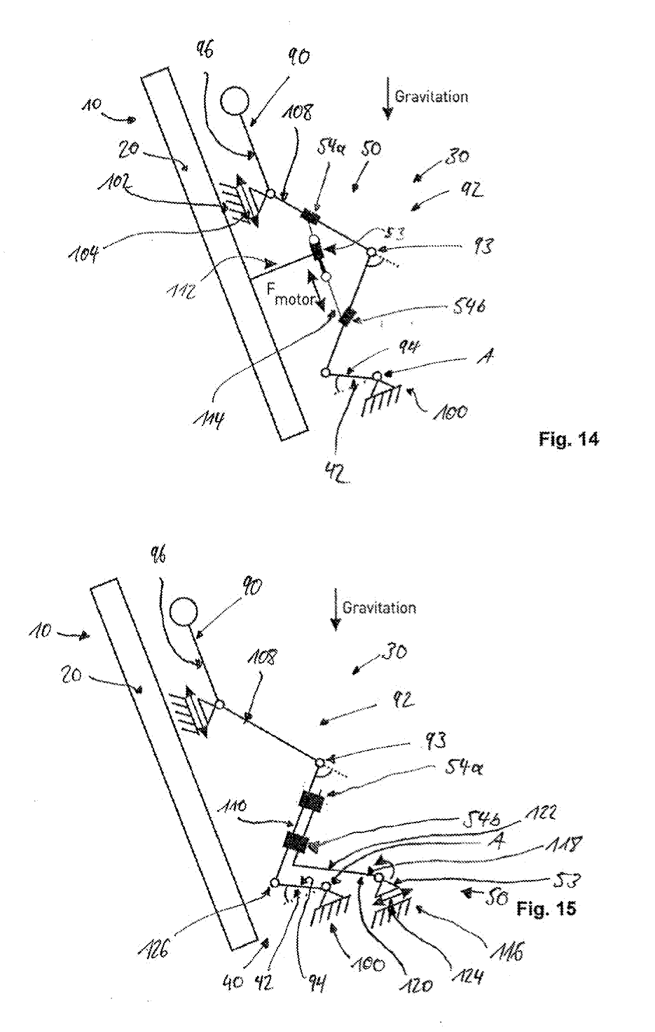

FIG. 14 A schematic view of a bed having a rehabilitation mechanism according to a third embodiment example;

FIG. 15 A schematic view of a bed having a rehabilitation mechanism according to a fourth embodiment example;

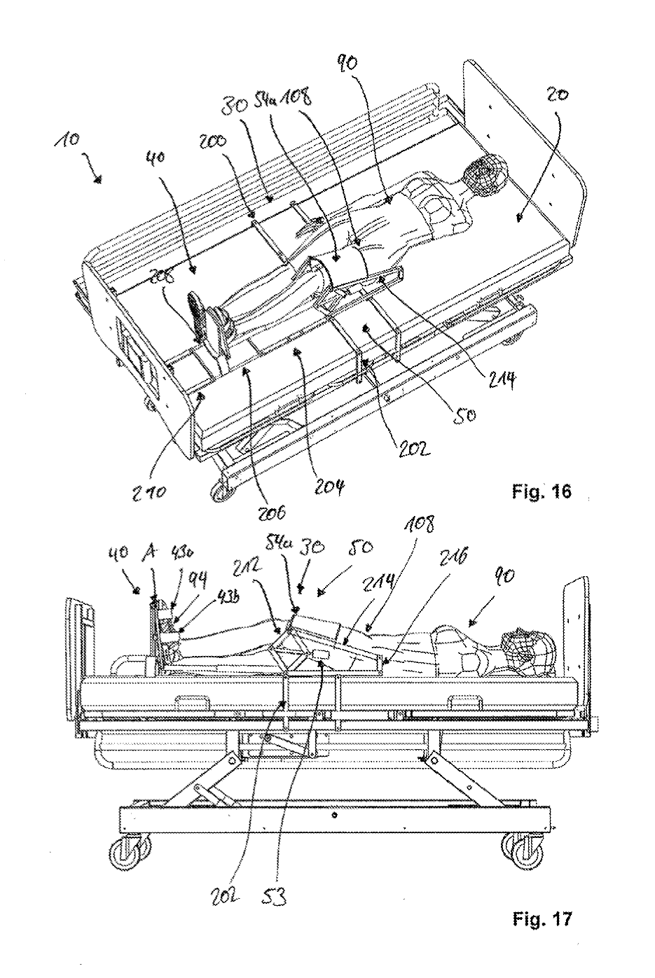

FIG. 16 A perspective view of a bed having a rehabilitation mechanism according to a fifth embodiment example;

FIG. 17 A side view of the bed from FIG. 16 having the rehabilitation mechanism in a first condition;

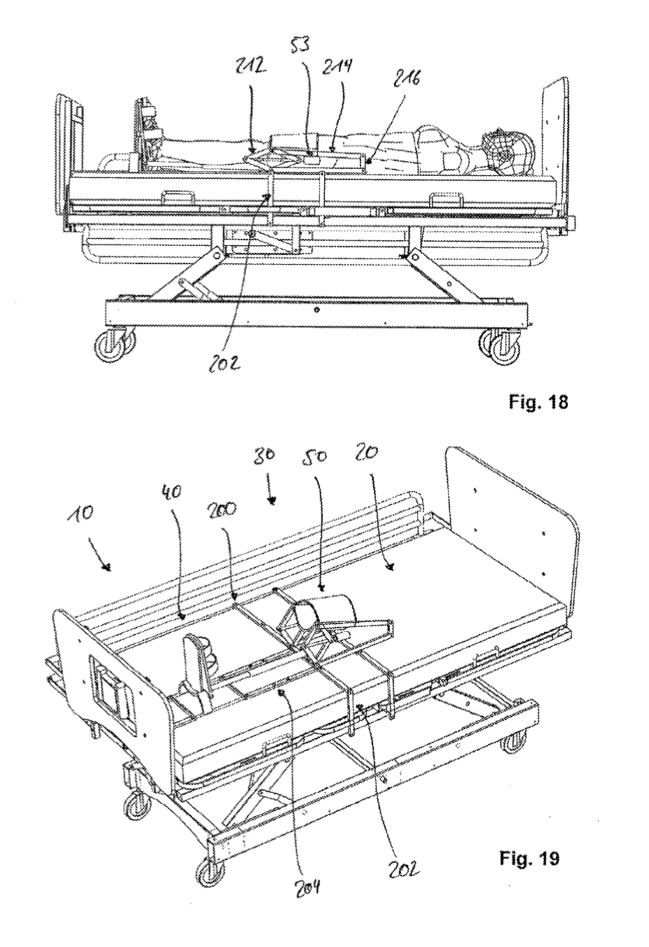

FIG. 18 A side view of the bed from FIGS. 16 and 17 having the rehabilitation mechanism in a second condition;

FIG. 19 A further perspective view of the bed from FIG. 16 through 18, without the patient;

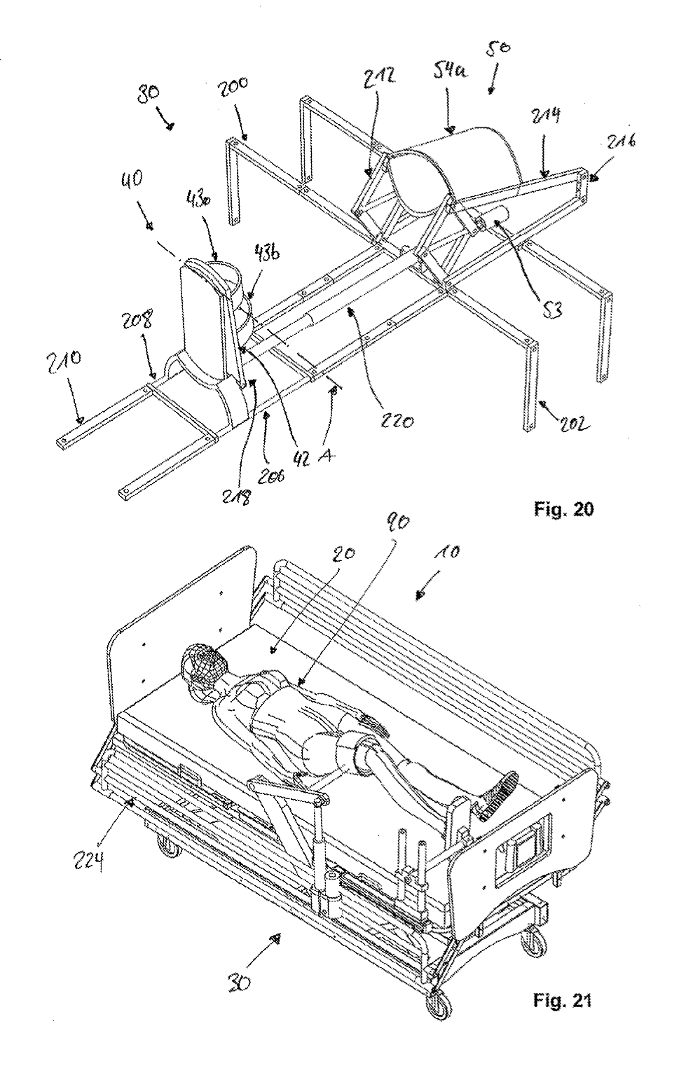

FIG. 20 A perspective detail view of the rehabilitation mechanism according to FIG. 16 through 19;

FIG. 21 A perspective view of a bed having a rehabilitation mechanism according to a sixth embodiment example;

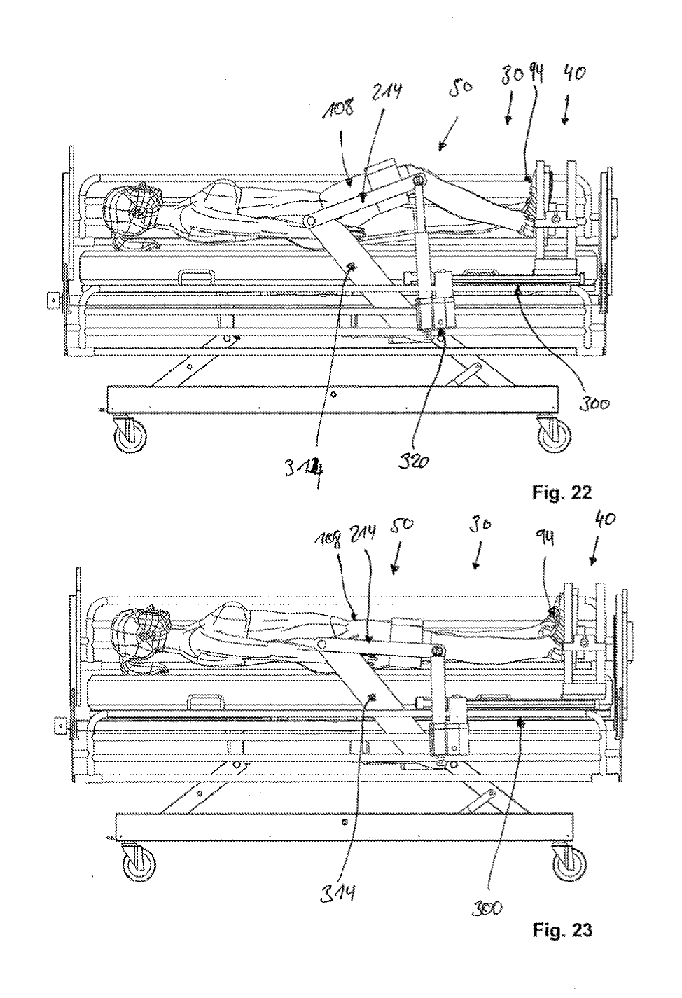

FIG. 22 A side view of the bed from FIG. 21 having the rehabilitation mechanism in a first condition;

FIG. 23 A side view of the bed from FIGS. 21 and 22 having the rehabilitation mechanism in a second condition;

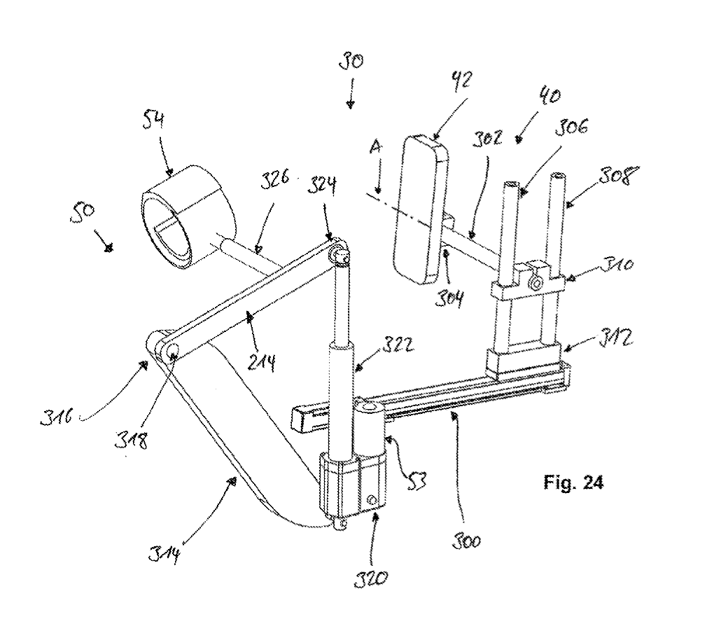

FIG. 24 A perspective detail view of the rehabilitation mechanism according to FIG. 21 through 23;

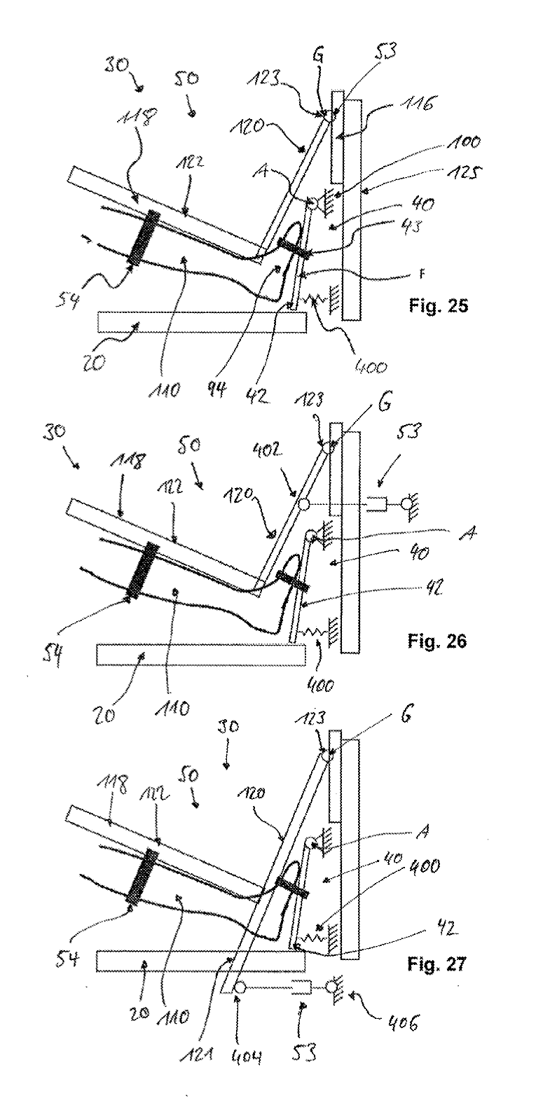

FIG. 25 A schematic side view of a rehabilitation mechanism according to a seventh embodiment example;

FIG. 26 A schematic side view of a rehabilitation mechanism according to an eighth embodiment example;

FIG. 27 A schematic side view of a rehabilitation mechanism according to a ninth embodiment example;

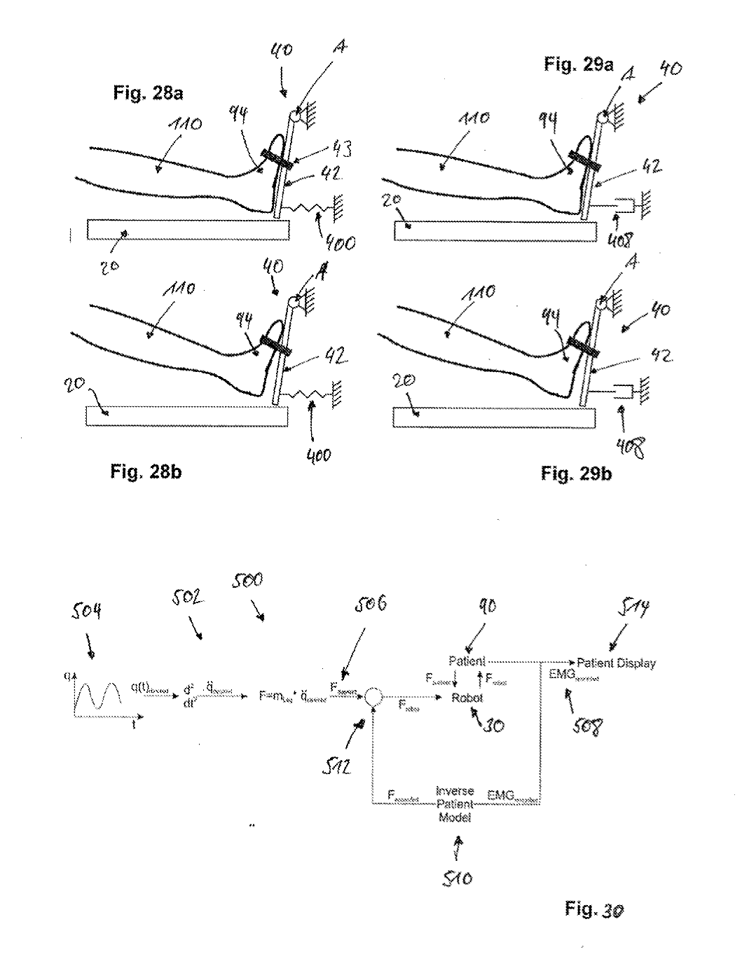

FIG. 28a A schematic side view of a foot module in a first position;

FIG. 28b A schematic side view of the foot module from FIG. 28a in a second position;

FIG. 29a A schematic side view of a foot module in a first position;

FIG. 29b A schematic side view of the foot module from FIG. 29a in a second position; and

FIG. 30 A closed-loop control circuit for EMG control.

In the description below of preferred embodiments of the present invention, identical reference numerals indicate identical or comparable components

FIG. 1 shows a bedridden or intensive-care patient 90 in a commercially available bed 10, particularly an in intensive-care bed, in a side view. The bed 10 shown can particularly be implemented for medical requirements typical of intensive-care beds, but can also be used in a non-intensive-care environment, particularly as a hospital bed, clinical bed, or gurney. In addition to apparatus for supporting monitoring measures (not shown), the bed 10 shown is characterized by a mattress 20 suitably designed at least for preventing bedsores. For an intensive-care bed, the bed 10 shown is further characterized by a mattress 20 additionally implemented for immediately manually resuscitating at least the heard and/or lungs 91 of an intensive-care patient 90, and non-conductive for performing defibrillations, and resistant to liquids, blood, and wiping disinfectant using commercially available disinfection means, wherein mattresses 20 having a non-divided or continuous design are preferred for cleaning and disinfecting purposes. In order to secure bedridden and particularly intensive-care patients 90 against falling out, the mattress 20 is entirely or partially surrounded by long 14 and transverse side barriers 15 for attaching to the long 12 and transverse sides 13 of a bed 11 or mattress frame 21 of the bed 10, typically supporting at least part of the monitoring apparatus (not shown). In order to be able to displace the bed 10, said bed has roller legs 16, for example. The roller legs 16 can be motor-driven in design for improving maneuverability. Embodiments wherein the bed 11 and/or mattress frame 21 are implemented for adjusting in height and/or in slope (whether lengthwise or transverse), wherein the head and foot ends can be preferably separately adjustable, that is, having different and/or opposite slopes from each other (not shown).

FIG. 2 shows a rehabilitation mechanism 30 according to the invention disposed on a bed 10 according to FIG. 1 and comprising a foot module 40, a knee module 50, and a control module 60 in a plan view.

It is evident how in a first preferred embodiment of the rehabilitation mechanism 30 said module comprises a foot 40 and a knee module 50 implemented as modules for disposing above the mattress 20 and for directly or indirectly supporting on a bed 11 or mattress frame 21. An advantage thereof is that commercially available, particularly non-divided and easily cleaned and disinfected mattresses 20 can be used, because (unlike particularly the standing table mentioned above), as said mattresses need not make space for mechanics. In addition, when rehabilitation is not taking place, the foot 40 and knee module 50 can be advantageously removed from the bed 11 or mattress frame 21, whereupon the bed 10 functions as a standard bed 10, such as a hospital bed, clinical bed, gurney, or intensive-care bed. The removed modules can be stowed on or under the bed 10, for example, until the rehabilitation is continued—optionally after prior cleaning or disinfection—or preferably used in the meantime for performing further planned automatic rehabilitations on other bedridden patients 90, whereby the investment costs incurred for the rehabilitation mechanism 30 are advantageously amortized more quickly.

In order to be able to operatively connect the foot module to the feet 94 and to operatively connect the knee module 50 to the knee joints 93 of the bedridden patient 90, in a further preferred embodiment of the rehabilitation mechanism 30 according to the invention the foot 40 and the knee module 50 are implemented as modules for fixing on both of the long sides 12 of the bed 10. The ability of the foot 40 and/or knee module 50 to be fixed can be provided in a low-cost embodiment by means of two guide rails 31, each of which can be mounted on one long side 12 of the bed 11 or mattress frame 21 and thus advantageously allow retrofitting for a plurality of existing beds 10. For fixing variably along the long sides 12, the foot 40 and the knee module 50 can comprise suitable fixing means 41 and 51 by means of which the modules 40 and 50 can advantageously be operatively connected to the feet 94 and knee joints 93 of the bedridden patient 90 corresponding to the anatomical conditions. In order to handle different widths of beds 10 and/or special anatomical considerations of the bedridden patient 90, fixing means 41 and 51 variably adjustable in not only the longitudinal direction but also the transverse direction of the bed 10 are finally preferred.

In a further preferred embodiment of the rehabilitation mechanism 30, the foot 40 and/or the knee module 50 can be electromechanical in design. A complete or partial electromechanical design of the foot 40 and/or knee module 50 has the advantage that electric motors can be actuated very simply and very precisely. Electric motors 45 or other actuators 53 (in contrast to pneumatic compressors, for example) are also relatively low-noise. Electromechanical drives can also be displaced very quickly, which can be advantageous in an emergency situation.

Alternatively or cumulatively thereto, in a further embodiment of the rehabilitation mechanism 30 the foot 40 and/or the knee module 50 can have a fluid-dynamic design. A complete or partial fluid-dynamic design of the foot 40 and/or knee module 50 has the advantage that the force transmission to the patient 90 can be generated by means of cushions 57, for example, being expanded and/or contracted via a hose system 58 by means of a vacuum pump 59. Said design would distribute the compressive and tensile forces F required for the motion of the legs 92 over a larger area on the patient 90, thus preventing risks of injury as the force F cannot be transferred at points potentially having greater intensity, but rather over a larger area having a lower point force.

The above is shown more clearly using the embodiment examples shown in the following FIGS. 3 through 7.

FIG. 3 shows a first embodiment example of a foot module 40 having an electrical and/or mechanical design in a side view.

It is evident how the foot module 40 can be constructed similarly to a fitness stepper, for example. To this end, the bedridden patient 90 typically puts on shoes. The step surfaces 42 of the foot module 40 can also be designed, however, so that training can be performed barefoot or in socks. The feet 94 can be fixed to the foot module 40 by means of elastic fixing bands 43, similar to a snowboard binding or the like. It is thus ensured that the soles of the feet 95 of the bedridden patient 90 make contact with the step surfaces 42 of the foot module 40 independently of any vertical position. In a further embodiment, the foot module 40 can comprise an adjusting lever 44 by means of which the distance between the step surface 42 and the sole of the foot 95, for example, can be finely adjusted.

The foot module 40 can have a mechanical and/or electromechanical design. In the mechanical variant, a bedridden patient can—assuming appropriate consciousness and fitness—can push against a mechanism and/or damping elements For an electromechanical variant, an electric motor 45 provides complete or partial support force, particularly at the level to which the bedridden patient is not able to independently execute motions of the legs 92 and/or load the soles of the feet 95. Finally, combined embodiments of a foot module 40 are also conceivable, wherein for example a mechanism can have supporting force from an electric motor connected or disconnected, or vice versa.

FIG. 4 shows a second embodiment example of a foot module 40 having an electrical and/or mechanical design in a side view. The step surfaces 42 with which the soles of the feet 95 of the patient 90 make contact or on which said patient stands after a complete or partial vertical repositioning are displaced in opposition to a mechanism and/or by means of an electric motor 45. An angle sensor 46 measures the current angle at which the step surfaces 42 are currently located, wherein at zero degrees the step surfaces 42 are perpendicular to the mattress 20. By means of the control module 60, the actual angle measured by means of the angle sensor 46 is compared with the planned target angle and any necessary support forces are calculated and executed.

According to said embodiment example (FIG. 4), two step surfaces 42 are provided, one for each of the patient's 90 feet. Said step surfaces are connected to the electric motor 45, for example the motor shaft, pivotally about the axis of the motor shaft. A stepping motion is thus advantageously achieved. The patient's foot can rotate about an axis near the tip of the foot. The elements applied to the patient's feet, such as fixing straps 43, thereby act as a retaining mechanism holding the feet in place. The only degree of freedom is raising and lowering the foot in the superimposed rotating motion about the motor axis of the electric motor 45. For a passive foot module 40 with no electric motor, a suspension in the form of a rotary bearing can be provided here, for example pretensioned using springs, in order to thus generate a load for the patient 90.

It is important for implementing a walking motion, stepping motion, and/or motion simulating stair-climbing that the device ensures that the foot can roll during the walking motion, stepping motion, and/or motion simulating stair-climbing, that is, the foot does not set down flat on the heel and tip at the same time, but rolls from the front part of the tip of the foot, across the middle of the foot, to the heel. For one thing, the loading situation on the patients body is thereby closer to natural loading when a foot module similar to a bicycle (cf. FIG. 3) is used. It can also thereby be better recognized in a vertical repositioning how much the rehabilitation has progressed. For another, said embodiment example allows the body's sensory signals transmitted from the soles of the feet to the brain to be similar to those from a real walking motion. Said motion is advantageous for rehabilitation and can lead to more rapid rehabilitation of the patient.

The embodiment examples according to FIGS. 3 and 4 both have the corresponding foot module operatively connected to mechanical end stops for preventing overextension or excess stretching of the foot 94, particularly the ankle joint.

Unlike the foot module 40, which can also be purely mechanical and particularly passive in design, a knee module 50 according to the invention is intended to continuously advantageously apply supporting forces just below, directly at, and/or just above the knee joint 93. The knee module 50 is inserted between the mattress 20 and the patient 90 beneath the knee joints 93 thereof and fixed to the bed 11 or mattress frame 21 for executing planned rehabilitation motions.

FIG. 5 shows a first embodiment example of a knee module 50 having an electrical and/or mechanical design in a section view (FIG. 5a) and a side view (FIG. 5b). In a low-cost, purely mechanical embodiment of a knee module 50, for example, the knee joint can be extended when extending a leg 92 by means of the foot module 40 against a spring or damping element 52, said element releasing the kinetic energy stored thereby during subsequent retraction of the leg 92, thus supporting the knee joint 93 during the bending motion executed thereby. Alternatively or cumulative thereto, electrical actuators 53 can be installed in the knee module 50, by means of which a planned support force can be applied to the knee joints 93 of the patient 90.

FIG. 6 shows a second embodiment example of a knee module 50 having an electrical and/or mechanical design in a section view. Unlike the embodiment example according to FIG. 5, two actuators 53 are not directly integrated in the knee module 50, but rather in the side fixing means.

Common to the embodiment examples according to FIGS. 5 and 6 is that the corresponding knee module 50 is operatively connected to mechanical end stops preventing overextension or excess stretching of the knee joint 93 by switching off the rehabilitation mechanism 30 if the forces become too great.

Also common to the embodiment examples according to FIGS. 5 and 6 is that the knee joints 93 of bedridden patients 90 can be fixed in position on the knee module 50 by means of a cuff 54. The support force of the actuators 53 can thereby be applied to the cuff 54 directly or by means of a gearbox 56. If the cuff 54 is preferably implemented in two parts and comprises a hook-and-loop closure 55 at the end thereof, for example, then the cuff 54 can be advantageously adapted to the anatomy of the bedridden patient 90. Two-part cuffs also provide the ability to be opened in case of overload.

FIG. 7 shows a knee module 50 having a fluid-dynamic design as a further embodiment example in a cross section. Instead of electromechanical actuators, a knee module 50 having a fluid-dynamic design preferably comprises two cushions 57 for positioning beneath the knee joints 93 of the patient in that said cushions are pushed beneath the patient's knee similar to a belt. Both cushions 57 are connected to a vacuum pump 59 by means of a hose system 58 and can be filled with and emptied of liquid, air or another fluid independently of each other. For example, the fill level of the cushions 57 can be controlled by means of a pressure sensor P and in combination with the control module 60, so that a planned support force is exerted on the knee joints 93 of the patient 90. The cushions 57 expand when filled and contract when emptied, much like a balloon. An expanded cushion 57 presses with equal force in the direction of the mattress 20 and in the direction of the knee joint 93 of the patient 90. Because the cushion 57 presses down against the mattress 20, the loaded knee joint 93 of the patient 90 bends in as planned. When the cushion 57 contracts, the leg 92 of the patient can extend again or be extended by the foot module 40. The knee joints 93 can in turn be fixed in position relative to the cushions 57 by means of a type of cuff 55 able to span both knee joints 93 as shown in FIG. 7, so that the cushions 57 remain in contact with the mattress 20.

In order to prevent overextending the knee joint 93, the cushions 57 can be controlled so that a residual amount of fluid remains in the cushion 57. To prevent excess expansion of the cushion and/or of the hose system 58, an overpressure valve set to a maximum threshold pressure can further be provided.

It is ultimately critical for the controlling of planned rehabilitation motions that the foot module 40 as well as the knee module 50 can be adapted to the anatomical conditions of the bedridden patient 90 in an individual home position of the patient 90 in which the legs 92 thereof take on an extended position aligned flush to each other. To this end, a final position can be finely matched, even perpendicular to the mattress 20, for example by means of the lever 44 provided on the foot module 40. Alternatively or cumulatively thereto, the actuators 53 of a knee module 50 having an electromechanical design can be displaced to a flush point of said home position, from which the planned rehabilitation motion can be executed and controlled. For a knee module 50 having a fluid-dynamic design, the cushions 57 can be implemented having a base fill level or a base-filled chamber system, wherein the base filling in turn corresponds to the desired flush point of said home position.

In a further preferred embodiment of the rehabilitation mechanism 30, said mechanism comprises at least one sensor F, EMG, by means of which a quantification of any self-contribution by bedridden patients 90 during planned automated controlling of rehabilitation motions is made possible by measuring compressive forces F at the soles of the feet 95 of the patient 90 and/or by measuring compressive and/or tensile forces F at the knee module 30 and/or by measuring muscle activity EMG in the legs 82 of the patient 90.

An objective clinical qualification of the change (improvement) can thereby be performed of the ability of the patient 90 to independently generate the forces required for the motion. Considered over the time period for rehabilitation (typically a plurality of days to weeks), said quantification can then provide insight into the rehabilitation process and success thereof. Based on said data provided by the at least one sensor F, EMG, the specialists (physicians, physical therapists, or the like) can adapt, or plan, the automated rehabilitation motions, particularly with respect to the methodology and/or intensity for each patient 90 over the course of the rehabilitation process.

In a further preferred embodiment of the rehabilitation mechanism 30, the control module 60 accesses compressive and/or tensile force measurement signals and/or EMG measurement signals for executing planned automated rehabilitation motions. The rehabilitation motions can thereby be performed automatically, so that the patient 90 obtains the right amount of support force at the right time. Or, in other words, the bedridden patient 90 obtains a support force only in the part of the motion cycle in which he requires support. The rehabilitation mechanism 30 behaves “transparently”, in contrast, in the part of the motion cycle in which the patient 90 can perform motions without help, that is, said mechanism merely follows the motion of the patient 90 without applying any force. Executing, that is, determining the support force required in each case, can be performed by measuring the compressive and/or tensile forces F and processing them in the control module 60 so that the rehabilitation mechanism 30 applies exactly the amount of force to the patient 90 that the patient 90 requires in order to perform the motion, but no more. Said concept can be referred to as “assist as needed.”

The active participation of the patient 90 can be maximized for the first time by means of monitoring and controlling. This is primarily done by measuring the activity of the legs as a function of the load applied to the patient 90 and held to a desired level by closed-loop control Quantification of the patient's 90 own contribution can take place by measuring compressive forces on the soles of the feet 95 of the patient 90 and/or by measuring muscle activity in the legs 92 of the patient 90. Monitoring and controlling patient activity is advantageous in that the patient 90 can be rehabilitated to the limit of his load-bearing capacity. Planned automated motions at the limit of load-bearing represent substantial therapeutic progress, particularly for intensive-care and/or comatose patients 90. Said measurements also provide insight into the clinical progress of the patient 90.

For safety reasons, the control module 60 continuously monitors all sensor values to that said module shuts down the rehabilitation mechanism 30 and/or emits suitable warning signals if inconsistencies or deviations from the planned rehabilitation are detected. In addition, particularly when used with coma patients 90, both the sensor side and the control side can be redundantly designed.

The rehabilitation mechanism 30 according to the invention is particularly suitable for commercially available or self-built beds 10 of all kinds, particularly for hospital beds, clinical beds, gurneys, and/or intensive-care beds.

FIGS. 8 through 10 below make this clear:

FIG. 8 shows an embodiment example of an adjusting mechanism 70 for raising the mattress frame 21 by e.g. 90° to a vertical position, in a side view.

In order to rehabilitate a bedridden patient 90 as close to the limit of his own ability as possible, the patients feet 94 should always bear as much of the patient's body weight as possible and thus contribute to a walking motion, stepping motion, and/or motion simulating stair-climbing. In order for the feet 94 to be loaded by the patient's body weight, it is necessary to bring the bedridden patient 90 into a vertical position. In order to ensure that the soles of the feet 95 of the bedridden patient 90 are in contact with the step surfaces 24 of the foot module 40 before vertical positioning, it is preferable to operatively connect the feet 94 of the patient 90 to the foot module prior to beginning the vertical positioning. The same applies to operatively connecting the knee joints 93 to the knee module 50. The level of vertical positioning (between 0 degrees=lying down and 90 degrees=standing) should be able to be freely adjusted as a parameter of the planned automated rehabilitation by the responsible physical therapist, that is, not only at 90° but also particularly at 45° or 60° or 75° or other arbitrary intermediate levels. A bed 10 according to the invention therefore comprises a suitably designed adjusting mechanism 70 for adjusting the mattress frame 21 at least between a horizontal and a vertical position, by means of which all other required positions than a horizontal and a vertical position can preferably also be assumed, and from which positions the mattress frame 21 can be returned to a horizontal position at any time. The adjusting mechanism 70 can comprise electric motor and/or hydraulic means for adjusting the mattress frame 21 connected to the bed frame by means of a joint, said means raising the mattress frame 21 including the mattress 20 and the patient 90 affixed thereto to the planned level of vertical positioning, for example by means of a driven angle-control mechanism. The vertical position thus assumed also advantageously allows the patient 90 to train the heart and circulatory system and to load the same optimally by adjusting the vertical positioning level according to the individual progress in healing.

FIG. 9 shows a first embodiment example of a stabilizing mechanism 80 at a preferred vertical level of e.g. 60°, in a side view. It is evident how the knee joints 93 of the patient 90 are fixed at maximum extension (that is, fully extended) until the planned prescribed vertical positioning. Said extension advantageously prevents the patient 90 from sliding down by bending the knee joints 93 during the process of vertical positioning. The force of the weight of the patient 90 thereby slowly shifts in the direction of the feet 94. A medical monitoring and/or supply apparatus typically provided in particular for intensive-care beds (not shown) can, if needed, be attached to the bed frame 11 of the bed 10 and/or can be vertically positioned together with the mattress frame 21.

In order to prevent the patient 90 from falling out of the bed 10, particularly as the vertical positioning of a bedridden patient 90 increases, it is necessary to suitably stabilize the bedridden patient 90 with respect to the mattress 20.

In a preferred embodiment of the bed 10 according to the invention, the stabilizing mechanism 80 therefore comprises a hip fixing element 81 by means of which the hips of the bedridden patient 90 can be fixed to the mattress 20.

FIG. 10 shows a second embodiment example of a stabilizing mechanism 80 at a preferred vertical level of e.g. 75°, in a side view.

In order to also allow at least partial relieving of the body weight in a vertical position, it is necessary to support the body weight of the bedridden patient 90 not only by means of the patients legs 92 but also partially by means of the stabilizing mechanism 80 in order to obtain a planned relief of the body weight. The amount of the body weight to be borne by the legs 92 of the patient 90 should be able to be freely adjusted as a further parameter of the planned automated rehabilitation by the physical therapist, preferably between fully relieved (0 kg) and fully loaded (full body weight). In a preferred embodiment of a bed 10 according to the invention, the stabilizing mechanism 80 therefore comprises a support harness 82 for receiving the bedridden patient 90, a winch 83 connected to the support harness 82 and the mattress frame 21 at the head end, and a sensor F by means of which the force of the patient's body weight on the legs 92 of the bedridden patient 90 can be controlled. The sensor F can be operatively connected to the winch 83 as shown. Alternatively or cumulatively thereto, however, a force sensor F associated with the foot module 50 can provide the signal data required by the control module 60 for controlling the body weight to be applied to the feet 94 of the patient 90.

Common to the embodiment examples according to FIGS. 9 and 10 is that each stabilizing mechanism 80 can be operatively connected to end stops, particularly for preventing the patient 90 from falling out or otherwise being injured, for example due to sudden opening and/or dropping of the stabilizing mechanism 80.

In daily use, the mattress 20 of a bed 10 for bedridden 90 should prevent the bedridden patient 90 from developing wounds or even bedsores. The mattress 20 should be suitably soft in design in order to prevent such damage. In addition to suitable foam materials, an arrangement in the mattress 20 of chambers 22 particularly for fully or partially filling with air is preferred (as shown in FIGS. 1 and 8 through 10). The mattress should also be suitably designed for immediately manually resuscitating at least the heart and/or lungs in the thorax 91 of intensive-care patients 90, particularly for a bed 10 implemented as an intensive-care bed. In a preferred embodiment of a bed 10 particularly implemented as an intensive-care bed, the mattress 20 thereof therefore comprises a mechanism 23 for emergency hardening, that is, for changing the hardness of the mattress 20 as a support at least in the region of the thorax 91 of the intensive-care patient 90 in case of need for immediately manually resuscitating the heart and/or lungs. One potential solution for hardening the mattress 20 of a bed 10 suitable as an intensive-care bed in a short time is to use a mattress 20 comprising chambers 22 for fully or partially filling with air at least in the region of the thorax 91 of the intensive-care patient 90. By releasing the air, the mattress 20 quickly becomes sufficiently hard for using as a support for resuscitation efforts, such as particularly the performing of heart and lung massage. Releasing the air can be done by means of a vacuum pump (not shown) under normal conditions. In case of power loss, the mechanical and manual opening of a larger opening in the cover (e.g., several centimeters in diameter) can be provided, so that the air escapes from the chambers 22 of the mattress under the weight of the intensive-care patient 90.

In order to be able to return the mattress frame 21 of a bed 10 particularly implemented as an intensive-care bed in case of an emergency, a mechanism 71 for emergency horizontal positioning of the mattress frame 21 is provided in a preferred embodiment of such a bed 10. The mechanism 71 for emergency horizontal positioning preferably comprises at least one emergency lever 72, operable for example from the head and/or foot end of the bed 10 particularly implemented as an intensive-care bed, for example symmetrically on the left and right sides thereof, and particularly operable by a foot 94. By actuating the emergency lever 72, rapid lowering of the mattress frame 21 into the horizontal position can be initiated in a short time (for example in only about 5 seconds). If the mattress 20 comprises a mechanism 23 for emergency hardening, said mechanism can also preferably be activated by actuating the emergency lever 72 as described. In addition, it can be provided that in an emergency, the rehabilitation mechanism 30, that is, the foot 40 and knee module 50, immediately stop in positions in which the legs 92 of the patient 90 are extended. The emergency lever 72 is preferably operatively connected to the electric motor and/or hydraulic means and thus allows activation of emergency horizontal positioning even in case of power loss, preferably mechanically by further actuating the emergency lever 72, particularly by pressing the lever even further down, or by pulling. If the adjusting of the mattress frame 21 of a bed 10 particularly implemented as an intensive-care bed is performed by means of electric motors, the emergency horizontal positioning can be performed by means of the electric motors under normal conditions. In order to be able to perform an emergency horizontal positioning even in case of power loss, non-self-braking or backdrivable motors are preferred. If the adjusting of the mattress frame 21 of a bed 10 particularly implemented as an intensive-care bed was performed by means of hydraulic systems, then under normal conditions the hydraulics should also allow rapid lowering of the mattress frame 21. Hydraulic valves for discharging the pressure cylinders of the hydraulic system rapidly, but in a controlled manner, can be used for this purpose. In case of power failure, the values can be opened manually by actuating the above-mentioned emergency lever 72, for example.

In order that bedridden or particularly intensive-care patients 90 are not subjected to excessive forces during rapid lowering of the mattress frame 21, the electric motor and/or a gearbox connected thereto for the adjusting mechanism 70 can be designed so that a predefined angular velocity is not exceeded. Alternatively or cumulatively thereto, a spring and damper system can also be provided for decoupling the motors from a mechanism in case of emergency and allowing rapid but controlled horizontal positioning of the mattress frame 21. In a preferred embodiment of a bed 10 particularly implemented as an intensive-care bed, the adjusting mechanism 70 therefore comprises an electronic angle meter 73 controlling the electric motor and/or hydraulic means of the adjusting mechanism 70 to a definable target angle and/or angular velocity.

A responsible therapist or comparable specialist ensures, for planned automated rehabilitation:
that the knee module 50 is correctly positioned beneath the knee joint 93 and is fixed to the bed 22 or mattress frame 21 and is electrically and/or hydraulically connected as needed;
that the foot module 40 is correctly connected to the feet 94 of the patient, is fixed to the bed 22 or mattress frame 21, and is electrically connected as needed; and
that the stabilizing mechanism 80 is put on correctly.

Using the control module 60 (cf. FIG. 11) the therapist controls the desired vertical positioning angle. The therapist then selects the desired stepping speed and starts the rehabilitation motion. The control module 60 thereby controls the interplay of the foot module 40 and the knee module 50 so that the legs 92 of the patient 90 are set in cyclical motion, particularly as follows: while the knee joint 93 of the left leg 92 is bent by the knee module 50, the foot module 40 performs an ankle joint extension on the left foot 94. The knee module 50 simultaneously performs an extension of the knee joint 93 on the right knee joint 93 and the right foot module 40 performs an ankle joint flexion. The fixation to the knee joint 93 and the stabilizing mechanisms 80 ensure that the patient 90 has extended the right leg 92 and thereby bears the entire or partial body weight on the right leg 92. By alternating said procedure between the left and right leg 92, the left and right leg 92 are alternating loaded and unloaded in that one knee joint 93 is extended while the other knee joint 93 is bent.

FIG. 11 shows a control schematic of the control module 60 for controlling planned rehabilitation motions. Accordingly, a desired activity can be set up, for example by a therapist or a comparable specialist. Said desired activity can then be compared in the control module 60 with the activity currently performed by the bedridden patient 90. The activity currently performed by the patient 90 is calculated as the difference between the rehabilitation motions produced by the patient 90 and the forces that the rehabilitation mechanism 30 exchanges with the patient 90. The control module 60 can calculate the required control parameters for determining how much force the rehabilitation mechanism 30 produces in which direction, at what time, with what amplitude, etc. Said forces then act on the patient 90 by means of the foot 40 and/or knee module 50 of the rehabilitation mechanism 30. Because the control module 60 of the rehabilitation mechanism 30 knows how great the forces generated by itself are, it can calculate how great the forces produced by the patient 90 are. The forces produced by the patient and the directions thereof are measured by the force sensors F, the positions of which are known.

Cumulatively thereto, further measurements can be performed or monitoring data can be incorporated. So-called physiological sensors for measuring muscle activity (EMG) can be provided on the patient 90, for example, particularly for checking the forces produced by the bedridden patient as calculated in the control module 60. In addition, physiological parameters such as heart rate or other vital parameters of the patient 90 can be measured and particularly controlled to a desired level, in that the level of vertical positioning of the mattress frame 21 is adjusted. This is often not possible, particularly for intensive-care beds. Thus, in addition to rehabilitation targets, care can be taken for the safety of the patient 90 in that the rehabilitation is interrupted prior to the onset of bodily overexertion, or is simplified to the point that the patient 90 experiences less bodily stress. The level of vertical positioning in particular can be reduced if the heart rate of the patient 90 increases too greatly or drops.

The control module 60 preferably comprises a control interface and display unit from which the functions described above can be accessed.

The control interface can preferably be used by the therapist for controlling some or all of the following processes, or adjusted to the therapeutic requirements and capabilities of the patient 90.
vertical position (particularly between 0 degrees and 90 degrees);
weight relief (particularly between 0% and 100% of the patient's body weight);
step frequency (particularly between 0 Hz and about 2.0 Hz or less, such as 1.5 Hz);
the radius of motion of the knee joints 93 in particular;
the amount of support force provided by the rehabilitation mechanism 30 to the patient 90 for supporting the execution of the motion (particularly between 0%=patient is moving the leg autonomously; and 100%=the patient is moved entirely by the system);
the amount of bodily activity (self-contribution) produced by the patient 90;
monitoring the heart rate of the patient 90;
additional technical and clinical parameters.

The display unit particularly displays the current status of the rehabilitation mechanism 30, particularly the current vertical position, current weigh relief, current activity, etc. . . .

The operator interface and display unit of the control module 60 is preferably also operatively connected to the emergency mechanisms 23 and/or 71.

Furthermore, the control module 60 can comprise a history memory recording the significant parameters of the planned and performed rehabilitation, in particular such as the vertical angle, the amount of weight relief, the activity, and the associated parameters and/or time duration. For example, by counting the bending and extending cycles for the knee joint 93, the number of steps can be calculated and saved as a clinical parameter.

FIGS. 12 through 15 show four further schematic embodiment examples of a bed 10 including a rehabilitation mechanism 30. The bed 10 comprises a mattress 20 as in the preceding embodiment examples, said mattress being a single piece, that is, having no recesses, slits, or the like. The rehabilitation mechanism 30 comprises a foot module 40 and a knee module 50. The patient 90 is shown schematically and the feet 94 of the patient 90 are disposed on the foot module 40. All four embodiment examples of the system shown, comprising the bed 10 and the rehabilitation mechanism 30, are designed so that the rehabilitation motion performed by the patient 90 is a walking motion, a stepping motion, or a motion simulating stair-climbing. To this end, the feet 94 of the patient are each fixed to step surfaces 42. The step surfaces 42 are rotationally disposed about an axis A. The axis A is fixed in location, as is illustrated by the fixed bearing 100. The step surfaces 42 are each pivotable independently of each other. It can also be provided that the step surfaces 42 are connected to a mechanism such that said surfaces are displaceable in opposition in order to support the walking motion, stepping motion, and/or motion simulating stair-climbing.

The foot 94 of the patient 90 is disposed on the step surface 42 such that the toes are near the axis A. Said implementation is identical for all four embodiment examples (FIG. 12 through FIG. 15). Also common to all four embodiment examples is that the back 96 of the patient 90 lies on a sliding bearing 102 or forms the same with the mattress 20. Said circumstance is indicated by the arrow 104; the back 96 of the patient 90 can slide “up and down” on the mattress 20. Alternatively, it can also be provided that the back 96 of the patient lies stationary on the mattress, and that instead the bearing 100 is implemented as a sliding bearing and is displaceable in the same direction as the arrow 104. As a rule, however, merely lifting the heels in conjunction with rotating about an axis A lying in a plane somewhat in front of the toes is sufficient for bending the knee without making it necessary for the foot module 40 to slide toward the patient 90 or for the patient 90 to slip on the mattress.

The differences among the four embodiment examples according to FIGS. 12 through 15 are particularly in the actuating of the knee module 50 and are described below.

According to FIG. 12, the knee module is substantially implemented as shown in FIGS. 5a through 9. Said module is supported on the mattress 20 by means of a support 106 and is connected to the thigh 108 just above the knee 93 by means of a cuff 54. The actuator 53 is implemented such that the distance between the support 106 and the cuff 54 varies. The cuff 54 is thereby rotationally connected to the knee end 107 of the knee module 50. The knee module 50 is thus substantially implemented as shown in FIGS. 5a through 6. By actuating the actuator 53, the distance between the action point of the cuff 54 and the mattress 20 is changed, and thus a stepping motion is performed. Due to the attachment of the foot 94 to the step surface 42, said surface being pivotally supported about the axis A, a rolling motion of the foot 94 is performed.

FIG. 13 shows a similar embodiment, wherein the cuff 54 is disposed not on the thigh 108 but rather on the calf 110, again just below the knee 93. The method of function is substantially the same. By actuating the actuator 53, the distance between the support 106 and the cuff 54 is changed, whereby the calf 110 is raised from the mattress 20 so that a walking motion, stepping motion, and/or motion simulating stair-climbing is performed.

FIG. 14 shows an embodiment example wherein two cuffs 54a, 54b are provided for the patient 90, wherein the cuff 54a is attached to the thigh 108 and the cuff 54b is attached to the calf 110. The actuator 53 is supported on the mattress 20 by means of a frame 112. The actuator 53 is coupled to the cuff 54a and to the cuff 54b by means of a transmission 140 and implemented for changing the distance between said two cuffs 54a, 54b substantially parallel to the mattress, in order to thus provide a walking motion, stepping motion, and/or motion simulating stair-climbing as a rehabilitation motion. The transmission 114 can be implemented by means of telescoping rods, for example, or by a type of scissor mechanism. Said arrangement is particularly advantageous if the patient is very weak and is barely able to perform the rehabilitation motion independently. A scissor mechanism has the further advantage that the forces do not need to be transmitted over long lever arms. The mechanical loading of the system is thereby reduced. Due to the two cuffs 54a, 54b, the forces required for extending and bending the leg are distributed to the thigh and the calf. It should be understood that two cuffs can be provided for all other embodiment examples as well, even if only one is shown. The force acting on the thigh and calf can thereby be less than if the same force were to be applied only to the thigh or only to the calf. Said mechanism is further very far from the hands of the patient. The risk of injury due to pinching is therefore reduced.

FIG. 15 shows a further embodiment example, wherein the knee module 50 acts exclusively on the calf 110 of the patient. According to the present embodiment example, the knee module 50 has an angle 118 comprising a first arm 120 and a second arm 122. The two arms extend at about right angles to each other, wherein the first arm extends above the foot 94 of the patient 90 and the second arm 122 extends substantially along the calf 110. The second arm 122 is fixed to the calf by means of both cuffs 54a, 54b. The first arm 118 is coupled to the actuator 53, said actuator applying a rotary motion to the angle 118. The actuator 53 itself is mounted on a sliding bearing 116 so as to be displaceable in the direction of the arrow 124, even if not absolutely necessary. In this manner, a walking motion, stepping motion, and/or motion simulating stair-climbing can be performed particularly well as a rehabilitation motion. Rolling and applying torques to the ankle joint 126 can be particularly advantageously performed. As can be seen in FIG. 15, the arm 120 of the angle 122 extends past the foot 94, so that the bearing 116 is disposed beneath the foot 94.

While the FIGS. 12 through 15 illustrate various embodiment examples purely schematically, FIGS. 16 through 27 show more detailed views of said embodiment examples. FIGS. 16 through 20 substantially show an embodiment example corresponding approximately to FIG. 14, but having only one cuff; FIGS. 21 through 24 show an embodiment example corresponding approximately to FIG. 12; and FIGS. 25 through 27 show an embodiment example corresponding approximately to FIG. 15.

Similar elements are labeled with identical reference numerals, so that full reference is made to the description above. In the following the special features of the individual embodiment examples are substantially explained and the differences from the preceding embodiment examples are shown.

FIG. 16 shows a bed 10 having a mattress 20 and patient 90. The rehabilitation mechanism 30 is releasably attached to the bed 10 and supported at the side by two struts 200, 202 on the mattress. The rehabilitation mechanism 30, particularly the knee module 50, can be aligned to the patient 90 by means of said struts 200, 202. The foot module 40 is coupled to the knee module 50 by means of a rail system according to the present embodiment example, said system being displaceable relative to the knee module 50 and allowing guiding of the foot module 40 on the two rails 6, 208. The foot module 40 is attached to the mattress 20 at the foot end by means of a further strut 210.

The rehabilitation mechanism 30 comprises a motor 53 disposed here on the knee module 50, said motor being most easily seen in FIG. 20. The motor 53 is coupled to a scissor mechanism 212, in turn pivoting a thigh strut 214, one end thereof being pivotally dispose on a cantilever 216. The thigh strut 214 extends substantially along the thigh 108 of the patient 90 and ends at about hip height. The thigh strut 214 supports a cuff 54a disposed about the thigh 108 for fixing the same relative to the mechanism. By actuating the motor 503, the scissor mechanism 212 is adjusted and the thigh strut 214 is displaced back and forth between a horizontal position (see FIG. 18) and a slightly pivoted position (see FIG. 17). When the thigh strut 214 is raised, the heel of the foot 94 of the patient 90 is simultaneously raised. The foot module 40 is designed to allow pivoting about an axis A present slightly forward of the toes of the foot 94. A walking motion is thus simulated. Because the foot module 40 can simultaneously slide on the rails 206, 208, “raising” of the entire foot 94, or drawing in toward the hips, as occurs in realistic walking motions, is possible when the thigh strut 214 is pivoted far enough.

The foot 94 of the patient is thereby fixed by means of two straps. As can be seen further in FIG. 20, a telescoping strut 220 is disposed between the step surface 42, more precisely the heel-side end 218 of the step surface 42, and the knee module 50. Said telescoping strut 220 can be implemented as a pneumatic spring or a mechanical spring and additional apply a force to the sole of the foot of the patient in that the step surface 42 is preloaded in a pivoted position, that is, in a position in which the heel of the foot 94 of the patient is raised. Said arrangement also promotes rehabilitation.

FIGS. 21 through 24 show an alternative. In the present alternative, the rehabilitation mechanism 30 is implemented so as to be operated solely from the side of the bed 10. Disposing the mechanism 30 beneath the patient 90 is not required, thereby largely avoiding lifting of the patient. The rehabilitation mechanism 30 according to FIGS. 21 through 24 is attached to the frame 224 of the bed 10 in a simple manner, such as by means of clamps or the like. Such a frame 224 is typically provided as a standard for hospital beds, so that mounting of the rehabilitation mechanism 30 according to the present embodiment example is particularly simple. The rehabilitation mechanism 30 (cf. FIGS. 22 through 24) comprises a rail 300 functioning as a support for the knee module 50 and the foot module 40. The foot model 40 is passive in design according to the present embodiment example and comprises a step surface 42 pivotally supported on a strut 302 by means of a bearing 304. The step surface 42 is adjustable along a longitudinal direction, that is, between a toe end and a heel end, relative to the strut, in order to thus adjust a pivot axis A. The height of the pivot axis A relative to the rail 300 is adjustable by means of two struts 306 and 308 on which the strut 302 is mounted by means of a clamping connection 310. The foot module 30 is mounted on the rail 300 by means of a mounting foot 312 and adjustable relative to the rail in the direction of the longitudinal direction of the rail 300.

The knee module 50 comprises a support 314 extending approximately to a hip of the patient 90 in an assembled state. A thigh strut 214 is disposed on the hip end 316 of the support 314 by means of a pivot bearing 318 and extends substantially along the thigh 108 of the patient 90 (cf. FIGS. 22 and 23). The support 314 is in turn displaceably coupled to the rail 300 by means of a body 320. The body 320 supports a motor 53 driving a piston 322, said piston in turn being connected to the thigh strut 212 by means of a pivot bearing 324 and pivoting the same in order to thus raise the knee 93 of the patient. In the present embodiment, the thigh 108 is connected by means of a cuff 54a coupled to the thigh strut 214 by means of a further strut 326. The strut 326 is in turn displaceably fixable to the thigh strut 214. As can be seen by comparing FIGS. 22 and 23, the rehabilitation mechanism brings about a pivoting of the thigh 108, whereby in turn a raising of the heel of the foot 94 is brought about, in order to thus produce a walking motion, stepping motion, and/or motion simulating stair-climbing. Due to the variable adjustability of the foot module 40 according to the present embodiment example, special loading conditions can be produced. As can be further seen from the present embodiment example, the rehabilitation mechanism 30 is particularly easy to stow and use on other beds 10 without having to lift the patient or transfer the patient to another bed. It is further also possible to couple two such mechanisms 30 to the bed 10 in order to apply the therapy to both legs of the patient at the same time.

FIGS. 25 through 27 largely schematically show an arrangement of a foot module 40 and a knee module as shown in FIG. 15. The knee module 50 engages exclusively at the calf 110 of the patient here as in FIG. 15. The knee module 50 has an angle 118 comprising a first arm 120 and a second arm 122. It is not absolutely necessary that both arms 120, 122 be disposed substantially at right angles to each other, rather, the angle 118 can also be implemented as a curved shaped. It is solely critical that one segment, formed here by the arm 122, extends substantially along the calf 110 of the patient and the other end, implemented here as the arm 120, is pivotally supported about an axis on a support 125, such as a bed frame or the like, by means of a joint 123. According to the present embodiment example, the joint 123 is disposed on a sliding bearing 116, even if not absolutely necessary. The calf 110 of the patient is coupled to the calf 122 by means of a cuff 54. In this manner, rotation of the calf 110 including the foot 94 about the axis G, here perpendicular to the plane of the drawing, is made possible. In the present embodiment example (FIG. 25), a motor 53 is further provided in the joint 123 and drives the angle 118 rotationally about the axis G.

The foot module 40 is preferably passive. Said module comprises a step surface 42 pivotally supported about an axis A by means of a bearing 100. The bearing 100 couples the foot module 40 to the support 125. The foot 94 is fixed to the step surface 42 by means of a strap 43. The step surface 42 is pretensioned by means of a spring 400 implemented as a compression spring on the heel side, so that a force is exerted on the sole of the foot 94 in order to configure a walking motion as realistically as possible. Because the foot 94 is fixed only by means of a strap 43, motion of the foot relative to the step surface 42 is possible and the heel can raise up away from said surface as shown in FIG. 25.

FIGS. 26 and 27 show alternative drive concepts. While the drive motor 53 in FIG. 25 is implemented as a rotary motor acting directly on the joint 123, the motor 53 according to FIG. 26 is implemented as a linear drive and can be implemented, for example, as a pneumatic or hydraulic piston. The motor 53 engages at an engagement point 402 at approximately the center of the arm 120 of the knee module 50. A rotation of the angle 118 about the axis G can also be produced by means of said motor 53.

FIG. 27 shows a further alternative for actuating the knee module 50. The first arm 120 comprises an extension 121 extending (in the assembled state) beneath the mattress 20. The motor 53 is coupled to the arm 120 at the end of said extension at a pivot point 404, wherein the motor 53 in turn is supported on a support 406 also disposed beneath the mattress 20. The motor 53 substantially corresponds to the motor 53 according to FIG. 26 and can be implemented, for example, as a pneumatic piston. Said arrangement can be advantageous if the rehabilitation mechanism 30 is disposed on the side of a bed, for example.

FIGS. 28a through 29b again clarify the freedom of the foot 94 when said foot is fixed to the step surface 42 of the foot module 40. FIGS. 28a, 28b show this for a passive foot module 40 and FIGS. 29a, 29b for an active foot module 40. According to FIGS. 28a, 28b, the calf 110 including the foot 94 of the patient is shown. The foot 94 is fixed to the step surface 42 by means of a strap 43. The step surface 42 is pivotally fixed about the axis A by means of a joint. The step surface is loaded by means of a spring 400 on the heel side.

When a knee module (not shown) is activated as shown in FIG. 28b, the calf 110 is pivoted and the foot 94 is simultaneously rotated about the axis A. In order to avoid injury to the patient and allow greater freedom, the heel of the foot 94 can release from the step surface 42. To this end, it can be provided that the spring 400 is implemented so as to allow rotation about the axis A only in a certain range. The raising of the sole of the foot 94 from the step surface 42 also leads to the walking motion, stepping motion, and/or motion simulating stair-climbing being more realistic. During natural walking, the foot is also raised from the ground and the sole of the foot is unloaded. This is also achieved by means of the foot module 40 according to the invention.

The same applies substantially to the active foot module 40 as shown in FIGS. 29a, 29b. The foot module 40 in turn comprises a step surface 42 pivotally disposed about the axis A. Unlike the embodiment example as in FIG. 28a, 28b, however, the spring 400 is replaced here by an active motor 408, implemented in the present embodiment example as a linear motor and able to be implemented as a pneumatic or hydraulic piston drive, for example. A targeted forced than thereby be applied to the foot 94 of the patient by means of the step surface 42 in order to achieve an even better stepping motion.

FIG. 30 finally clarifies a closed-loop control circuit for EMG control. The closed-loop control circuit 500 comprises a servo control 502 in which a defined motion profile 504 over time is converted into a force setting parameter 506. Said force setting parameter 506 is transferred to the patient 90 via the rehabilitation mechanism 30 (here designated as F Robot). The reaction of the patient is measured by means of an EMG measurement device 508 and fed back into the closed-loop control circuit via an inverse patient model 510 at the point 512. The measured EMG data are displayed to the patient and/or a therapist via a patient display 514. The therapist can adjust the defined motion profile 504 in order to thus achieve particularly good rehabilitation of the patient.

The present invention provides a rehabilitation mechanism 30 improved relative to the prior art and able to be integrated in all known clinical procedures without a problem, for patients 90 who have become bedridden for orthopedic, intensive-care, and/or neurological limitations on activity. Without having to transfer said patient 90, the present invention enables planned automated rehabilitation of at least the joints, muscles, and tendons of the legs 92 of bedridden patients 90. Due to the modular construction, the rehabilitation mechanism 30 can be quickly removed and is not a hindrance in either an emergency or in daily clinical activity. The ability to load the feet 94 with the complete or partial body weight of the patient 90 further trains the musculature and the skeleton and prevents degeneration of the musculoskeletal system. The ability to vertically position also trains the cardiovascular system. For orthopedic and intensive-care and neurological patients 90 this is equally important. In addition to commercially available or self-build hospital or clinical beds 10, a rehabilitation mechanism 30 according to the invention can easily also be attached to and removed from commercially available or self-built gurneys or intensive-care beds 10, regardless of whether the bedridden patient 90 can be brought into a partially or fully vertical position in the corresponding bed, wherein at any position of the bedridden patient 90 between a horizontal or an assumed vertical position a rhythmic loading and unloading of the soles of the feet 95 of bedridden patients 90 is supported.

1. A rehabilitation mechanism (30) implemented for planned, automated rehabilitation of at least the joints, muscles, and tendons of the legs (92) of a bedridden patient (90) and comprising at least
a foot module (40) for operatively connecting to the feet (94) of the bedridden patient (90),
a knee module (50) for operatively connecting to the knee joints (93) of the bedridden patient (90), and
a control module (60) for controlling planned rehabilitation motions of at least the joints, muscles, and tendons of the legs (92) of the bedridden patient (90) by means of the foot (40) and/or knee module (50);
wherein at least the knee module (50) is implemented as a module for disposing between the patient (90) and the mattress (20) and supported directly on a bed (11) or mattress frame (21), and
wherein said mechanism can be reversibly releasably fixed to a hospital bed as a module and/or can be stowed beneath the hospital bed.

2. The rehabilitation mechanism (30) according to claim 1, characterized in that the rehabilitation motion is a walking motion, step motion, and/or a motion simulating stair-climbing.

3. (canceled)

4. The rehabilitation mechanism (30) according to claim 1, characterized in that in addition to the knee module (50) the foot module (40) is also implemented as a module for disposing above the mattress (20) and supported directly or indirectly on a bed (11) or mattress frame (21).

5. (canceled)

6. The rehabilitation mechanism (30) according to claim 1, characterized by two guide rails (31) for mounting one on each long side (12) of a bed (11) or mattress frame (21).

7. The rehabilitation mechanism (30) according to claim 6, characterized in that the foot (40) and the knee module (50) comprise suitable fixing means (41, 51) for variably fixing along the long sides (12), by means of which the modules (40, 50) can be advantageously operationally connected to the feet (94) and knee joints (93) of the bedridden patient (90), corresponding to the anatomical conditions, wherein the fixing means (41, 51) are variably adjustable in the transverse direction of the bed (10).

8-15. (canceled)

16. The rehabilitation mechanism (30) according to claim 1, characterized in that the foot module (40) is constructed similarly to a fitness stepper having step surfaces (42).

17. (canceled)

18. The rehabilitation mechanism (30) according to claim 1, characterized in that the foot module (40) comprises an adjusting lever (44) by means of which a distance between a step surface (42) and the sole of the foot (95) can be finely adjusted, for example.

19. The rehabilitation mechanism (30) according to claim 1, characterized in that said mechanism comprises at least one sensor (F, EMG) by means of which any self-contribution by the bedridden patient (90) when executing planned, automated rehabilitation motions can be quantified by measuring compressive forces (F) on the soles of the feet (95) of the patient (90).

20. The rehabilitation mechanism (30) according to claim 1, characterized in that said mechanism comprises at least one sensor (F, EMG) by means of which any self-contribution by the bedridden patient (90) when executing planned, automated rehabilitation motions can be quantified by measuring compressive and/or tensile forces (F) at the knee module (50).

21. The rehabilitation mechanism (30) according to claim 1, characterized in that said mechanism comprises at least one sensor (F, EMG) by means of which any self-contribution by the bedridden patient (90) when executing planned, automated rehabilitation motions can be quantified by measuring muscle activity (EMG) or muscle forces (F) in the legs (92) of the patient (90).

22. The rehabilitation mechanism (30) according to claim 1, characterized in that the control module (60) accesses compressive and/or tensile force measurement signals for controlling planned, automated rehabilitation motions.

23. (canceled)

24. The rehabilitation mechanism (30) according to claim 1, characterized by a biofeedback module for providing visual and/or audible feedback to the patient (90).

25. A bed (10) for bedridden patients (90), at least comprising a rehabilitation mechanism (30) according to claim 1.

26. The bed according to claim 25, further comprising an adjusting mechanism (70) suitably designed for adjusting the mattress frame (21) at least between a horizontal and a vertical position from which the mattress frame (21) can be returned to the horizontal position at any time; further comprising a stabilizing mechanism (80) suitably designed for stabilizing the bedridden patient (90) with respect to the mattress (20), wherein the stabilizing mechanism (80) comprises a hip fixing element (81) by means of which the hips of the bedridden patient (90) can be fixed to the mattress (20).

27-28. (canceled)

29. The bed (10) according to claim 26, characterized in that the stabilizing mechanism (80) comprises a support harness (82) for receiving the bedridden patient (90), a cable winch (83) attached to the support harness (82) and the head of the mattress frame (21), and a sensor (84), by means of which the body weight force on the legs (92) can be applied to the legs (92) of the bedridden patient (90).

30-32. (canceled)
